(19) United States
(12) Patent Application Publication
(10) Pub. No.: US 2002/0015838 A1
(43) Pub. Date: Feb. 7, 2002

(54) Photosensitive transfer sheet and method of forming photosensitive transfer sheet

(76) Inventors: Mikio Totsuka, Shizuoka-ken (JP); Tomizo Namiki, Shizuoka-ken (JP); Yohnosuke Takahashi, Shizuoka-ken (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/737,808

(22) Filed: Dec. 18, 2000

(30) Foreign Application Priority Data
Dec. 17, 1999 (JP) 11-358752

(51) Int. Cl. B32B 5/16; B32B 27/08

(52) U.S. Cl. 428/324; 428/510; 428/520; 428/328

(57) ABSTRACT

A photosensitive transfer sheet which has a support, and on the support, a color material layer. The color material layer contains an inorganic pigment and/or a metal pigment, a binder and a precipitation prevention agent. Since precipitation of pigment is suppressed due to the precipitation prevention agent, uniform color tone can be obtained.

### BACKGROUND OF THE INVENTION

1. Field of the Invention

The present invention relates to a photosensitive transfer sheet which is used, in the field of printing, in the preparation of pre-press proofs for color correction and images for display. More particularly, the present invention relates to a photosensitive transfer sheet applied to cases in which the transfer sheet has a metallic color tone or a white color tone.

2. Description of the Related Art

Generally, correction printing is carried out in order to confirm the final finish of printed matter. In this case, a color proof is used to carry out correction printing of a color printed matter.

Conventional color correction methods using photopolymers (pre-press proofing) are an overlay method and a surprint method.

In the overlay method, a plurality of color proofing sheets, on each of which a separated image of a respective color is provided on a transparent support, are readied. By superposing these sheets (the obtained laminate is called a color test sheet), color correction is carried out. In accordance with this method, by superposing color proofing sheets of from two to four colors as needed, a multi-color image can be obtained. Accordingly, there is the advantage that this method is simple and can be used in continuous inspections. However, interposing plural supports greatly affects the color tone and the gloss.

Further, in the surprint method, separated images of respective colors are formed successively on a single support so as to form a multi-color image. In accordance with this method, the color density is not affected by plural supports as is the case in the overlay method. Further, distortion of color which occurs when the color proofing sheets are superposed can be avoided. As a result, an image formed by hues which are even more similar to the hues of the original printing method can be obtained.

For example, Japanese Patent Application Laid-Open (JP-A) Nos. 59-97140 and 61-188537 disclose, as an image forming material which can be used in both the overlay method and the surprint method, a photosensitive transfer sheet in which a peelable layer formed by an organic polymer and a photosensitive resin layer are provided in that order on a support (hereinafter referred to as “temporary support” upon occasion).

The color proofing sheet having the multicolor image for color correction is obtained by exposing and developing the photosensitive transfer sheet to form separated images, and thereafter, repeatedly transferring the separated images onto an arbitrary support.

There are the following two cases: cases in which the color material expressing the color image is contained in the photosensitive resin layer, and cases in which the color material expressing the color image is provided as a layer between the photosensitive resin layer and the support.

Pigments (yellow (Y), magenta (M), cyan (C), black (K)) having hues which are equivalent or similar to those of color inks generally used in printing are used as the standard colors in the color materials used in color correction as described above. However, in the case of color printing, there are often cases in which special printing is carried out, such as, in addition to the aforementioned hues, hues having luster or gloss of a metallic tone such as a gold or silver color (hereinafter referred to as “metallic gloss” upon occasion), or white color hues or the like. In these cases as well, it is necessary to check the finish of the printed matter in advance by using the color proof.

Because the color correction has properties which should reflect the finish of the printed matter, excellent quality of the color material is required, and in particular, excellent quality is required of the uniformity of the density of the color material.

Currently, high quality materials for color proofs using the standard hues of Y, M, C and K are commercially available. However, for color proofs using white hues or hues having a metallic tone, such as gold or silver, luster or gloss, materials having sufficient quality for printing correction are not yet available.

When color proof materials, i.e., photosensitive transfer sheets, having a white hue or a metallic toned color hue are prepared, metal fine powder pigments or inorganic white pigments or the like, which have a large particle diameter and a high specific gravity as compared to organic pigments of Y, M, C and K, must be used. Thus, because these pigments tend to precipitate in the coating solution, a coating solution having an excellent dispersed state cannot be prepared. As a result, in the color material layer formed by coating a coating solution having a poor dispersed state, uniformity of the density of the color material cannot be maintained, and a photosensitive transfer sheet which is suitable for printing correction cannot be obtained.

If a highly viscous vehicle such as a printing ink used for printing is used as a coating solution, a dispersed state which is uniform to a certain extent can be maintained even if the pigment is a metal powder pigment having a large particle diameter and a high specific gravity. However, in the case of color proofs, the color material layer is several μm or less. In order to form, by coating, a thin layer of several μm or less, a coating solution having a low viscosity must be used. Accordingly, when a pigment having a large particle diameter and a high specific gravity is used as the color material, even if a uniform dispersed coating solution is first prepared, it is easy for the pigment to precipitate in a short time, and the pigment precipitates while being coated on the support. Thus, it is difficult to stably prepare a color proof material having a color material layer with a uniform pigment content. As a result, in the formed image as well, the hue and the gloss are not uniform. Thus, there is the problem that pigments having a large particle diameter and a high specific gravity are not suitable for use as materials for color correction.

This problem is not limited to pigments which are glossy such as metal pigments or the like. The same can be said for color proofs for printing white color which use an inorganic white pigment such as titanium oxide, because the specific gravity of such inorganic white pigments is high.

As described above, it is currently the case that there has not yet been developed a photosensitive transfer material in which, when a pigment having a high specific gravity and/or a large particle diameter, such as a metal pigment or an inorganic pigment, is used as a color material therein, the pigment does not precipitate or the like in the coating solution, and thus, the pigment is contained uniformly in the color material layer formed on the support.

### SUMMARY OF THE INVENTION

The present invention solves the above-described problems of the conventional art, and achieves the following objects.

Namely, an object of the present invention is to provide a photosensitive transfer sheet which can form an image having a uniform color tone and a high degree of metallic gloss or a high degree of whiteness.

Another object of the present invention is to provide a photosensitive transfer sheet in which, during the manufacture thereof, deterioration in the pigment dispersability due to precipitating of an inorganic pigment and/or metal pigment in the coating solution can be suppressed, and which has a color agent layer in which an inorganic pigment and/or a metal pigment is dispersed uniformly.

In order to achieve the above objects, the inventors of the present invention conducted many diligent studies relating to dispersion stability in cases in which a pigment having a large particle diameter and/or a high specific gravity is used as the color material, and learned the following.

(1) In a case in which the color material which is used is a pigment having a large particle size and/or a high specific gravity such as a mica pigment or a metal pigment, even if dispersing agents which are used conventionally and dispersing agents having a high dispersion performance are used for dispersion, the color material tends to gradually precipitate. Accordingly, a sufficient dispersion stability, to the extent that allows a uniform color material density suitable for color correction to be obtained, cannot be ensured.

(2) In the above case, in order to ensure the dispersion stability of a pigment or the like having a high specific gravity, the coating solution must be viscous to a certain extent. However, on the other hand, low viscosity is needed for the formation of a thin film. Thus, mutually opposite properties are required.

On the basis of the above knowledge obtained by the present inventors, the present inventors solved the previously-described problems by the following means: a photosensitive transfer sheet comprising: a support; and a color material layer containing an inorganic pigment and/or a metal pigment, a binder, and a precipitation prevention agent.

Another aspect of the present invention is a method of forming a photosensitive transfer sheet comprising the steps of: (a) forming a solution containing at least an inorganic pigment and/or a metal pigment, a precipitation prevention agent, and a binder; (b) coating a support material with the solution; and (c) drying the coating.

Namely, the present invention is a photosensitive transfer sheet having a color material layer on a support. The color material layer is formed by coating and drying a coating solution containing at least an inorganic pigment and/or a metal pigment, a precipitation prevention agent, and a binder.

### BRIEF DESCRIPTION OF THE DRAWINGS

FIG. 1 is a cross-sectional structural view illustrating an example of a photosensitive transfer sheet of the present invention in which a photosensitive color material layer is provided on a support.

FIG. 2 is a cross-sectional structural view illustrating an example of a photosensitive transfer sheet of the present invention in which a photosensitive resin layer and a color material layer are provided in that order on a support.

FIG. 3 is a cross-sectional structural view illustrating an example of a photosensitive transfer sheet of the present invention in which a photosensitive resin layer, a color material layer and a peelable layer are provided in that order on a support.

FIG. 4 is a cross-sectional structural view illustrating an example of a photosensitive transfer sheet of the present invention in which a protective layer, a photosensitive color material layer, and a peelable layer are provided in that order on a support.

FIG. 5 is a cross-sectional structural view illustrating an example of a photosensitive transfer sheet of the present invention in which a protective layer, a photosensitive resin layer, a color material layer, and a peelable layer are provided in that order on a support.

FIG. 6 is a cross-sectional structural view illustrating an example of an image receiving sheet in which an image receiving layer and a cushioning peelable layer are provided in that order on a support.

### DESCRIPTION OF THE PREFERRED EMBODIMENTS

In the photosensitive transfer sheet of the present invention, the color material layer provided on the support contains an inorganic pigment and/or a metal pigment, and a precipitation prevention agent. Namely, the present invention is a photosensitive transfer sheet having at least a color material layer on a support, and the color material layer is formed by coating and drying a coating solution containing at least an inorganic pigment and/or a metal pigment, a precipitation prevention agent, and a binder.

Details of the photosensitive transfer sheet of the present invention will be described hereinafter. Through this description, a method of forming images by using the photosensitive transfer sheet of the present invention will become clear. Hereinafter, description will be given mainly by using examples in which the pigment is a pearl pigment or a metal fine powder pigment or the like (hereinafter occasionally called “metallic glossy pigment”). However, this description is equally applicable to white color pigments of organic pigments.

The photosensitive transfer sheet of the present invention has at least a color material layer on a support. If necessary, other layers, such as a photosensitive resin layer, a peelable layer, a protective layer, and the like, may be provided.

### Color Material Layer

The color material layer includes an inorganic pigment and/or a metal pigment, and refers to a layer having a uniform glossiness. This layer contains at least an inorganic pigment and/or a metal pigment, a precipitation prevention agent and a binder, and as needed, may also contain a photosensitive resin, a non-glossy coloring agent, a wetting dispersing agent, or the like. When the pigment is an inorganic white pigment, the color material layer is a color material layer of a white color hue.

The color material layer having a uniform gloss is a layer having a metallic tone luster or gloss (metallic gloss) which includes a metallic glossy pigment such as a pearl pigment or a metal fine powder pigment as will be described later (hereinafter, occasionally called “metallic glossy color material layer”). In particular, the color material layer is a layer in which, when the degree of gloss of the surface is measured by the following method, the degree of gloss is 1.2 or more.

### Measurement of Degree of Gloss

A spectral photometric calorimeter (e.g., CM-512m3 manufactured by Minolta Co., Ltd.) is used in the measurement of the degree of gloss. Xenon pulse light is irradiated onto the surface of a sample from directions 25° and 75° from the vertical axis direction of the sample surface. The reflected light is received by a light-receiving sensor at a direction 45° from the vertical axis. Spectral photometry is carried out, and the L* values are determined. The ratio of the values at the time of incidence at 25° and 75° (i.e., L*(25°)/L*(75°)) is defined as the degree of gloss.

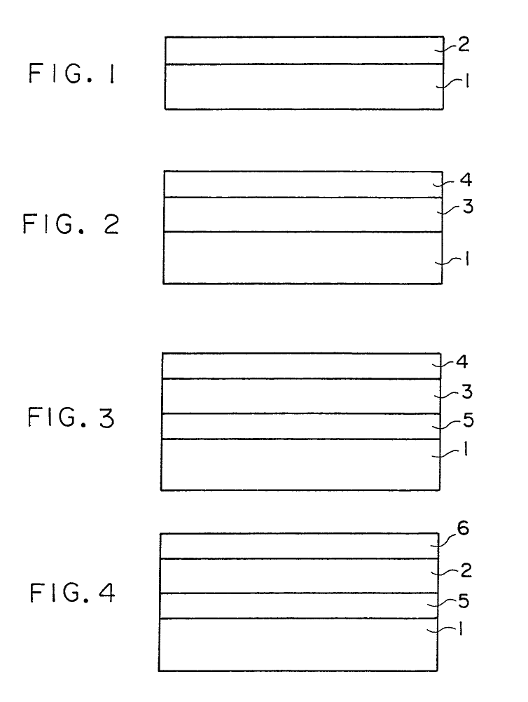

Examples of the color material layer are the following. As illustrated in FIG. 1, the color material layer may be a layer (a photosensitive color material layer) formed to include an inorganic pigment and/or a metal pigment, a precipitation prevention agent, and a binder, as well as a photosensitive resin. Or, as illustrated in FIG. 2, the color material layer may be a layer (color material layer) containing an inorganic pigment and/or or a metal pigment, a precipitation prevention agent, and a binder. In the case of the latter, a photosensitive resin layer including a photopolymerizable monomer, a photopolymerization initiator and a binder is laminated on the color material layer, and functions to form images due to photoreaction.

FIG. 1 is a cross-sectional structural view showing an example of the photosensitive transfer sheet of the present invention in which a photosensitive color material layer is provided on a support. FIG. 2 is a cross-sectional structural view illustrating an example of the photosensitive transfer sheet of the present invention in which a color material layer and a photosensitive resin layer are provided in that order on a support. Note that in the figures of the present application, 1, 1′ represent supports, 2 represents a photosensitive color material layer, 3 denotes a color material layer, 4 represents a photosensitive resin layer, 5 denotes a peelable layer, 6 represents a protective layer, 7 refers to a cushioning peelable layer, 8 is an image receiving layer, and 9 designates an image receiving sheet.

### Inorganic and/or Metal Pigment

By using an inorganic pigment and/or a metal pigment as the color material in the color material layer (or in the photosensitive color material layer), a color material layer which is glossy and has a metallic tone hue including gold or silver or the like (i.e., a metallic glossy color material layer), or a white color material layer having a high degree of whiteness, is formed.

Examples of the inorganic pigment and/or metal pigment are known metal fine powder pigments, metallic glossy pigments such as pearl pigments, and inorganic white pigments such as oxides or carbonates. The inorganic pigment and/or metal pigment is selected appropriately in accordance with the object.

Examples of pearl pigments include natural pearl essence, mercury chloride, basic white lead, bismuth oxychloride, mica, and the like. Among these, mica pigments are particularly preferable from the standpoints of stability and cost.

Examples of metal fine powder pigments are fine powder pigments of aluminum, gold, silver, copper, zinc and the like. Among these, aluminum is particularly preferable from the standpoints of gloss and cost and the like.

The particle size of the metallic glossy pigments (other than mica pigments) is preferably 0.5 to 50 μm, and more preferably 1 to 30 μm.

The particle size means the average particle diameter of the pigment particles, and can be measured by, for example, an optical microscope or an electron microscope.

The pearl pigment and the metal fine powder pigment may be used in any of various forms which may be selected appropriately as needed. However, from the standpoint of being able to obtain a high degree of gloss with a low filled amount, it is more preferable that the pigment is in the state of tabular grains. Among the aforementioned pigments, mica pigments are particularly preferable as pigments having a tabular form. Among mica pigments, titanium dioxide covered mica, which has a structure in which a titanium dioxide film is laminated on the mica particle, is the most preferable.

As to the specific form of the mica pigment, a thickness of 0.05 to 0.7 μm and a particle size of 1 to 50 μm is preferable. A particle size of 5 to 30 μm is more preferable.

When the thickness exceeds 0.7 μm, the interference effect of the light due to light reflection at the boundary surface between the mica and the titanium dioxide may deteriorate, and the degree of gloss may deteriorate. Further, when the particle size is less than 1 μm, the degree of gloss may deteriorate. When the particle size exceeds 50 μm, the surface smoothness of the color material layer may deteriorate, and it may not be possible to a uniform metallic gloss.

The particle size of the mica pigment refers to the long diameter of the tabular grain. In the same way as described above, the particle size may be measured by an optical microscope or an electron microscope.

Examples of the inorganic white color pigment are inorganic compounds such as metal oxides, metal carbonates, and the like.

Suitable examples of the metal oxides include titanium oxides such as titanium dioxide, aluminum oxide, zinc oxide, silicon oxide, magnesium oxide and the like. Suitable examples of the metal carbonates include calcium carbonate and the like.

The particle diameter of the inorganic white pigment is preferably 0.01 to 10 μm, and more preferably 0.01 to 8 μm, and even more preferably 0.1 to 5 μm.

The amount of the inorganic pigment and/or metal pigment contained in the color material layer may be suitably selected in accordance with the object, such as the hue or the degree of gloss of the formed image, and is preferably 0.1 to 10 g/m², more preferably 0.2 to 7 g/m², and even more preferably 0.3 to 3 g/m².

### Precipitation Prevention Agent

When a known inorganic pigment and/or metal pigment, or a pigment having a large particle diameter and/or high specific gravity such as silica is used as the color material, examples of the precipitation prevention agent are agents which can maintain the dispersability of the pigment in the coating solution. For example, thixotropic agents are suitable.

By including a thixotropic agent in the dispersion solution (the coating solution for the color material layer) which contains the inorganic pigment and/or the metal pigment, the thixotropic agent functions to increase the viscosity and prevent the pigment from precipitating when the dispersion solution is in a stationary state. Then, when the dispersion solution is coated onto the support, when shearing forces act thereon, the thixotropic agent functions to markedly reduce the viscosity of the dispersion solution, and to enable filtering of the dispersion solution and/or coating thereof onto the support at a uniform thickness.

Accordingly, the greater the thixotropy of the thixotropic agent, the more the dispersion stability of the pigment is ensured, and the more stably a uniform color material layer having a uniform content of pigment can be formed by the coating solution in which the pigment is dispersed uniformly. Thus, thixotropic agents having high thixotropy are preferable.

It is known that many thixotropic agents exhibiting thixotropy have the following property: in a dispersion solution, a portion of the thixotropic agent precipitates and exhibits a three-dimensional network structure.

Preferable examples of the thixotropic agent are those which easily precipitate to form needle-shaped or layer-shaped crystals, such as fatty acid amides, polyamide based waxes, metal soaps, organic bentonites, polyethylene oxide compounds, and water-added castor oil wax. In addition, inorganic particles such as silicon dioxide fine powder and the like are also suitable as the thixotropic agent.

Among these, polyamide based waxes, polyethylene oxides, polyethylene oxide compounds, and metal soaps are particularly suitable. Higher aliphatic compounds are also preferable as the thixotropic agent.

Examples of fatty acid amides and polyamide waxes include stearic acid amides, behenic acid amides, and straight chain amides of myristic acid, lauric acid, palmitic acid, and the like. From the standpoint of exhibiting good thixotropy, polyvalent amides which are divalent or greater are more preferable than monovalent amides. Examples of the metal soaps include metal salts such as stearic acid, palmitic acid and the like. Preferable examples of the metal salts are salts of aluminum, calcium, magnesium and the like.

The added amount of the precipitation prevention agent in the color material layer is preferably 0.01 to 2 parts by weight with respect to 1 part by weight of the known inorganic pigment and/or metal pigment.

When the added amount is less than 0.01 parts by weight, the precipitating preventing effect is low, and the dispersability of the inorganic pigment and/or the metal pigment cannot be maintained uniform. When the added amount exceeds 2 parts by weight, the crystallization and the like, within the layer, of the compound exhibiting thixotropy may become a cause of image defects or the like.

The molecular weight of the polyethylene oxide compound is preferably 300 to 50000. The added amount of the polyethylene oxide compound in the color material layer is preferably 0.02 to 0.4 parts by weight with respect to 1 part by weight of the inorganic pigment and/or metal pigment.

When the added amount is less than 0.02 parts by weight, the precipitating preventing effect is low, and it may not be possible to maintain the dispersability of the inorganic pigment and/or the metal pigment uniform. When the added amount exceeds 0.4 parts by weight, problems arise such as the speed of development is lowered and the like.

A single one of the aforementioned precipitation prevention agents may be used, or two or more types may be used in combination.

By using such a precipitation prevention agent having a high degree of thixotropy, even in cases in which low viscosity in production is suitable for coating, a pigment having a large particle size and/or high specific gravity can be dispersed uniformly and maintained uniform, and uniformity of the components in the layer formed by coating can be achieved. Further, the density of the pigment can be increased, and a layer can be formed in which the metallic gloss is higher or the whiteness is excellent. Moreover, even when the dispersion solution, in which the glossy pigment is dispersed, is filtered or the like in the manufacturing step, it is difficult for the filter to become clogged, and processing can be carried out easily.

### Wetting Dispersing Agent

It is preferable to add a wetting dispersing agent to the color material layer. The wetting dispersing agent is preferably an agent which acts on the surface of the pigment particle to vary the wettability of the particles with the solvent or the binder, accelerates the dispersion of the inorganic pigment and/or metal pigment, suppresses aggregation of the pigment, and improves the redispersability when the pigment precipitates. For example, the wetting dispersing agent can be appropriately selected from among surfactants having these characteristics.

Examples of such surfactants are phosphoric ester surfactants such as polyamide phosphate, polycarbonates such as polyacrylate and the like and amine salts thereof, anionic compounds such as carboxylates such as sodium oleate, sulfuric ester salts and sulfonic acid salts, cationic compounds such as acetic oleyl amine, aminopropylamine diolate, and the like.

Among these, polycarbonate amine salts are particularly preferable.

The added amount of the wetting dispersing agent is preferably 0.001 to 1.0 parts by weight, more preferably 0.002 to 0.5 parts by weight, and even more preferably 0.003 to 0.05 parts by weight, with respect to 1 part by weight of the inorganic pigment and/or metal pigment.

### Binder

Examples of the binder are thermoplastic polymers which can be dissolved in a developing solution at the time of development. For example, in the case of an alkaline developing solution, examples of the binder are acid polymers such as benzylmethacrylate, methacrylic acid based copolymers, phenol resins, and the like.

The added amount of the binder within the color material layer is preferably 0.3 to 3 g/m², and more preferably 0.5 to 2 g/m².

### Photosensitive Resin

In the photosensitive transfer material of the present invention, a photosensitive resin is used. A latent image is formed by irradiating light imagewise onto the photosensitive resin. Thereafter, due to developing processing with an alkaline developing solution, the irradiated portions or the non-irradiated portions are dissolved and developed so that an image is formed. Accordingly, as described above, when the color material layer itself is provided with a latent image forming function (as in the case of FIG. 1), the photosensitive resin is included in the color material layer. (This is called the photosensitive color material layer.) Further, when the coloring layer itself is not provided with a latent image forming function (as in the case of FIG. 2), a photosensitive resin layer is laminated on the color material layer which includes the inorganic or the metal pigment, and the photosensitive resin is included in the photosensitive resin layer.

Photopolymerizable resins are preferable as the photosensitive resin. The photopolymerizable resin is formed by a photopolymerizable monomer, a photopolymerization initiator, and a binder, and is appropriately selected from among various types of materials used for known photosensitive transfer sheets. Among these, an alkali developing type photosensitive resin is preferable.

Specifically, in the case of formation of a positive image from a negative original image (negative→positive type), the following compositions are preferable as the photosensitive resin: a blend composition of an azide photosensitizing agent such as 2,6-di(4′-azidebenzal)cyclohexane and a phenol novolak resin; or a blend composition of a photopolymerization initiator such as Michler's ketone and a polyfunctional monomer such as trimethloylpropane triacrylate, using a benzylmethacrylate-methacrylic acid copolymer as a binder.

Further, in the case of formation of a positive image from a positive original image (positive→positive type), a quinone diazide based photosensitive agent such as o-quinone diazide is preferable.

In the aspect illustrated in FIG. 1, when a photosensitive color material layer containing an inorganic pigment and/or a metal pigment, a precipitation prevention agent and a photosensitive resin is formed on a support, the layer thickness of the photosensitive color material layer is preferably 0.5 to 10 μm, more preferably 0.5 to 8 μm, and even more preferably 1 to 5 μm. When the layer thickness is less than 0.5 μm, sufficient image density cannot be obtained. When the layer thickness exceeds 10 μm, the sensitivity and resolution deteriorate.

When a photosensitive resin layer is layered on the color material layer including the inorganic pigment and/or metal pigment, generally, the thickness of the photosensitive resin layer is preferably 0.5 to 10 μm, and more preferably 1.0 to 5 μm. Here, the layer thickness of the color material layer is preferably 0.3 to 10 μm, and more preferably 0.5 to 5 μm.

Details of the materials used in the photosensitive resin layer such as the photopolymerizable monomer, the photopolymerization initiator, the binder and the like, and well as the method of forming the photosensitive resin layer are disclosed in, for example, Japanese Patent Application Publication (JP-B) Nos. 46-15326, 46-35682, and Japanese Patent Application Laid-Open (JP-A) Nos. 47-41830, 48-93337, 49-441, 51-5101, 59-97140, and the like.

### Non-Glossy Coloring Agent

In order to adjust the color hue of the image, the color material layer (or the photosensitive color material layer; hereinafter, the term “color material layer” may be used upon occasion to encompass the photosensitive color material layer as well) may include, in addition to the inorganic pigment and/or metal pigment, an organic coloring agent and/or an inorganic non-glossy coloring agent. By appropriately varying the amount of the non-glossy coloring agent which is used, various hues can be achieved.

The non-glossy coloring agent may be added to the color material layer, or, as in the above, may be added into a photosensitive resin layer layered on the color material layer.

The non-glossy coloring agent is a coloring agent which is such that a degree of gloss of the color material layer which includes only the non-glossy coloring agent as the color material (hereinafter, such a layer will be referred to upon occasion as the “non-glossy color material layer”) is (L*(25°)/L*(75°))<1.2 as measured by the above-described method of measuring the degree of gloss. The non-glossy coloring agent may be appropriately selected from among known color materials such as pigments and dyes. Among these, organic pigments whose color tones match or are close to pigments (yellow, magenta, cyan, black) used for printing color correction are suitable. The type and the amount of the non-glossy coloring agent are selected in accordance with the purpose. Details of non-glossy coloring agents are disclosed in, for example, JP-A No. 59-97140. For example, azo pigments, phthlocyanine based pigments, anthraquinone based pigments, dioxazine based pigments, quinacridone based pigments, isoindolinone based pigments, nitro pigments and the like are suitable. Specific examples are the following:

(1) as the yellow color pigment: Hansa Yellow G, Hansa Yellow 5G, Hansa Yellow 10G, Hansa Yellow A, Pigment Yellow L, Permanent Yellow NCG, Permanent Yellow FGL, Permanent Yellow HR, and the like;

(2) as the red color pigment: Permanent Red 4R, Permanent Red F2R, Permanent Red FRL, Lake Red C, Lake Red D, Pigment Scarlet 3B, Bordeaux 5B, Alizarin Lake, Rhodamine Lake B, and the like;

(3) as the blue color pigment: Phthalocyanine Blue, Victoria Blue Lake, Fast Sky Blue, and the like;

(4) as the black pigment: carbon black, and the like.

The average particle diameter of the non-glossy coloring agent is preferably 0.03 to 1 μm, and more preferably 0.05 to 0.5 μm.

The color material layer is formed by coating on a support by a conventional coating method, and then drying, a coating solution used for forming the color material layer (coating solution for color material layer) which is prepared by dissolving or dispersing, in a solvent, the inorganic pigment and/or metal pigment, precipitation prevention agent, and binder, as well as other components if needed.

Here, the coating solution for the color material layer, which has been prepared but not yet coated, is maintained in a state in which the glossy pigment is dispersed stably therein, due to the high viscosity resulting from the thixotropy of the thixotropic agent. When appropriate shearing forces are applied in the stage of coating the coating solution onto the support, the viscosity of the coating solution is lowered to the extent that coating of a thin layer is enabled, and the coating solution, which is in a state in which the glossy pigment is dispersed uniformly therein, can be coated to a uniform thickness. As a result, a color material layer exhibiting a uniform glossiness can be obtained.

The solvent which can be used when preparing the coating solution for the color material layer can be appropriately selected from alcohols such as ethyl alcohol and propyl alcohol; ketones such as acetone and methylethyl ketone; esters such as ethyl acetate; aromatic hydrocarbons such as toluene and xylene; ethers such as tetrahydrofuran and dioxane; amides such as DMF and N-methylpyrolidone; cellosolves such as methyl cellosolve; and the like. One type of solvent may be used, or a combination of two or more solvents may be used.

### Peelable Layer

A color proof formed by the surprint method is exposed imagewise, and the image formed by developing is transferred onto an image receiving body. From the standpoint of carrying out transfer uniformly and with good reproducibility, it is preferable to provide a peelable layer formed from an organic polymer, between the support and the color material layer of the photosensitive transfer sheet, as illustrated in FIGS. 3 through 5.

Photosensitive transfer sheets having peelable layers are disclosed in JP-A Nos. 59-97014 and 61-188537, and Japanese Patent Application No. 6-88600 and the like.

In the present invention, the peelable layer is preferably a layer formed by an alcohol soluble polyamide, or a blend of an alcohol soluble polyamide and a hydroxystyrene based polymer.

Examples of the alcohol soluble polyamide are linear polyamides synthesized by conventional methods from dibasic fatty acids and diamines, or ω-amino acid, lactam or derivatives thereof. The linear polyamide may be a homopolymer, a copolymer or a block polymer. A polyamide having a substituent on the carbon atom or the nitrogen atom which forms the main chain, or a polyamide having a bond other than a C—C bond or a C—N—C bond at the main chain thereof may also be used.

Examples of the aforementioned polyamide are linear homopolyamides such as nylon 3, 4, 5, 6, 8, 11, 12, 13, 66, 610, 1313, or polymers of metaxylenediamine and adipic acid, polymers of trimethylhexamethylenediamine and terephthalic acid, polymers of 1,4-diaminomethylcyclohexane and suberic acid, and the like; copolymer polyamides such as nylon 66, 6/66/610, 6/66/610/612, 6/66/12, ε-caprolactam/adipic acid/hexamethylenediamine/4,4′-diaminodicyclohexylmethane, and the like; and derivatives of N-methyloyl substituents, N-alkoxyalkyl substituents, N-aryloxyalkyl substituents and the like of various polyamides.

Examples of the hydroxystyrene based polymer include polyhydroxystyrene and derivatives thereof (substituted by substituents such as an alkyl group, alkoxy group, aralkyl group and the like), as well as copolymers of hydroxystyrene and other vinyl compounds.

Examples of the vinyl compounds include vinyl toluene, halogenated styrene, vinyl ethylbenzene, methoxystyrene; vinyl heterocyclic compounds such as N-vinylcarbazole, vinyl pyridine, vinyl oxazole, vinyl pyrolidone and the like; vinyl cycloalkanes such as vinyl cyclohexane; (meth)acrylic acid esters such as alkyl (meth)acrylate, aralkyl (meth)acrylate and aryl (meth)acrylate; acrylamides such as acrylonitrile; and the like.

The repeated structural unit of hydroxystyrene in the copolymer is preferably included in an average number ratio of 40% or more with respect to the total number of repeated structural units.

The ratio (weight mixed ratio) of the alcohol soluble polyamide and the hydroxystyrene based polymer is preferably from 4:6 to 9:1 from the standpoints of adhesion of the peelable layer to the image receiving side of the support at the time of transfer under high humidity and peelability of the peelable layer from the support under high humidity.

The peelable layer may be formed as follows: after the alcohol soluble polyamide and the hydroxystyrene based polymer are dissolved in an appropriate solvent so as to prepare the coating solution, the coating solution is coated on a support and dried. Any of various surfactants may be added to the coating solution as surface improving agents. Among these, fluorine-based surfactants are effective.

The layer thickness of the peelable layer is preferably 0.1 to 2.0 μm, more preferably 0.2 to 1.5 μm, and even more preferably 0.3 to 1.0 μm.

### Protective Layer

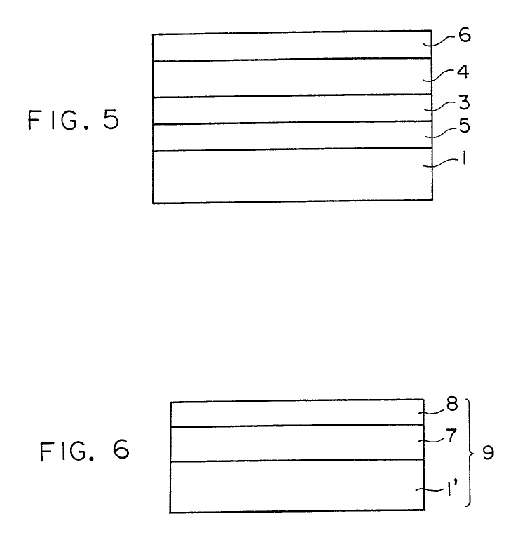

A protective layer may be provided. In particular, in the case of a negative→positive type photosensitive transfer sheet, as shown in FIGS. 4 and 5, it is preferable to provide a protective layer on the negative-type photosensitive resin layer.

The protective layer functions to prevent inhibition of polymerization (a decrease in the degree of polymerization) mainly due to the oxygen in the air diffusing in the photosensitive layer (photosensitive color material layer, photosensitive resin layer) during exposure. A high molecular material having low oxygen gas permeability is preferable as the material used for the protective layer.

The high molecular material is preferably a high molecular substance such as polyvinyl alcohol, polyvinyl acetate, methyl vinylether-maleic acid anhydride copolymer, polyvinylpyrolidone, gelatin, gum arabic, or the like. The protective layer may be formed by coating and drying a solution in which the high molecular substance is dissolved in an appropriate solvent.

Examples of the solvent are water, methyl alcohol, ethyl alcohol, propyl alcohol, or mixed solvents thereof.

The layer thickness of the protective layer is preferably 0.1 to 5 μm.

### Support

The support is chemically and thermally stable, and a flexible material (substance) is used therefor. If needed, the support may be chemically light permeable.

Specifically, any of the various substances disclosed in JP-A Nos. 47-41830, 48-9337 and 51-5101, such as cellulose acetate, polyvinyl chloride, polystyrene, polypropylene, and the like can be used. Among these, polyethylene terephthalate, polycarbonate, and heat treated products thereof are preferable.

A backing layer formed from a high polymer substance such as polyvinyl butyral, vinyl chloride-vinyl acetate copolymer, cellulose acetate or the like may be provided on the surface of the support at the side at which the color material layer is not provided, for the purpose of improving processability. Any of various additives such as a matting agent or the like can be included in the backing layer.

As described above, by using a precipitation prevention agent in the coating solution for forming the color material layer, a deterioration in the dispersability of the pigment due to precipitating of the inorganic pigment and/or metal pigment in the coating solution at the time of production can be suppressed, and the photosensitive transfer sheet of the present invention, which has a color material layer in which the inorganic pigment and/or metal pigment is dispersed uniformly, can be obtained stably and at a low cost. By using this photosensitive transfer sheet, an image (color proof) having a high degree of metallic gloss or a high degree of whiteness and having a uniform color tone can be formed.

### Image Receiving Sheet

The image receiving sheet may be in any form, provided that it has the function of being able to carry the image formed on the photosensitive transfer sheet of the present invention. For example, the image receiving sheet may have the following form: at least an image receiving layer is provided on a support which is different than that of the photosensitive transfer sheet. If necessary, between this support and the image receiving layer, other layers may be provided such as a cushioning layer for improving the close fit which is a cause of roughness of the surface of the image receiving layer, an undercoat layer, a peelable layer, and the like. The cushioning layer may be a cushioning peelable layer which functions as a peelable layer. The image receiving sheet can be used for not only the photosensitive transfer sheet of the present invention, but also for a photosensitive transfer sheet having a non-glossy color material layer (hereinafter referred to upon occasion as “non-glossy image formation transfer sheet”).

For example, as shown in FIG. 6, the image receiving sheet may be of a form in which a cushioning peelable layer and an image receiving layer are layered in that order on a support.

Examples of the support forming the image receiving sheet are the same as the aforementioned examples of the support which can be used for the photosensitive transfer sheet.

### Image Receiving Layer

The image receiving layer is a layer whose main component is an organic polymer binder.

The organic polymer binder (hereinafter referred to upon occasion as “receiving layer binder polymer”) is preferably a thermoplastic resin. Examples thereof include homopolymers and copolymers of acrylic monomers such as acrylic acid, methacrylic acid, acrylic esters, methacrylic esters, and the like; cellulose polymers such as methyl cellulose, ethyl cellulose, and cellulose acetate; homopolymers and copolymers of vinyl monomers such as polystyrene, polyvinyl pyrolidone, polyvinyl butyral, polyvinyl alcohol, polyvinyl chloride, and the like; condensation polymers such as polyester, polyamide, and the like; and rubber based polymers such as butadiene-styrene copolymer.

From the standpoint of obtaining the appropriate adhesion between the image receiving layer and the image forming layer, the image receiving layer binder polymer is preferably a polymer having a glass transition temperature (Tg) of less than 90° C. To this end, a plasticizer may be added to the image receiving layer. The image receiving layer binder polymer preferably has a Tg of 30° C. or more, in order to prevent blocking between sheets.

The layer thickness of the image receiving layer is preferably 0.3 to 7 μm, more preferably 0.7 to 4 μm, and even more preferably 1 to 3 μm.

When the layer thickness is less than 0.3 μm, the film strength at the time of transfer onto a printing paper is insufficient and it is easy for the layer to break. When the layer thickness exceeds 7 μm, the gloss of the image after transfer onto the printing paper may increase such that the similarity to the original printed matter may deteriorate.

### Cushioning Layer

The cushioning layer includes a thermoplastic polymer as an essential component, and if necessary, may include a plasticizer, a stabilizer, a surfactant, a matting agent or the like.

With the cushioning layer, when an image formed by plural colors is received on an image receiving sheet by using plural photosensitive transfer sheets on which images are formed by exposure and development, the cushioning layer can absorb the convex and concave portions (steps) formed by layers already transferred onto the image receiving layer, such that the tight fit between the photosensitive transfer sheet and the image receiving sheet can be improved, thereby contributing to the formation of a multicolor image which does not have any portions which have not been transferred. Further, with the cushioning layer, when a multicolor image formed on an image receiving sheet which serves as an intermediate image receiving body is transferred all at once onto the final support (the printing paper), because the cushioning layer can deform in accordance with the convex and concave portions existing on the surface of the printing paper, convex and concave portions corresponding thereto are also formed in the surface of the image receiving layer after transfer. The non-image portions are not excessively glossy, and accordingly, the cushioning layer is effective in forming an image which resembles the actual printed matter.

In order to impart a cushioning property, a material having a low modulus of elasticity, a material having rubber elasticity, or a thermoplastic polymer which easily softens due to the application of heat thereto can be used.

The modulus of elasticity is, at room temperature, preferably 10 to 500 kgf/cm², more preferably 20 to 300 kgf/cm², and even more preferably 30 to 150 kgf/cm².

In order for foreign substances such as rubber or the like to be made to sink into the cushioning layer, the penetration (at 25° C., 100 g, 5 seconds) as stipulated by JIS K2530 is preferably 10 or more.

The glass transition temperature of the cushioning layer is 80° C. or less, more preferably 50° C. or less, and even more preferably 25° C. or less. In order to control physical properties such as Tg, a plasticizer can be suitably added in the polymer binder.

Examples of the thermoplastic polymer include rubbers such as urethane rubber, butadiene rubber, nitryl rubber, acrylic rubber, natural rubber and the like, as well as polyethylene, polypropylene, polyester, styrene-butadiene copolymer, ethylene-vinyl acetate copolymer, ethylene-acrylic acid copolymer, vinyl chloride-vinyl acetate copolymer, vinylidene chloride resin, plasticizer-containing vinyl chloride resins, polyamide resin, phenol resin, and the like.

Examples of the plasticizer include phthalates such as dibutyl phthalate, di-n-octyl phthalate, di(2-ethylhexyl) phthalate, dinonyl phthalate, dilauryl phthalate, butylauryl phthalate, butylbenzyl phthalate and the like; aliphatic dibasic acid esters such as di(2-ethylhexyl) adipate, di(2-ethylhexyl) sebacate, and the like; triesters of phosphoric acids such as tricresyl phosphate, tri(2-ethylhexyl) phosphate, and the like; polyol polyesters such as polyethylene glycol ester and the like; epoxy compounds such as esters of epoxidized fatty acid; and the like.

In addition to the above-listed general plasticizers, acrylates such as the following can also suitably be used in accordance with the type of the binder that is used: polyethylene glycol dimethacrylate, 1,2,4-butanetriol trimethacrylate, trimethylolethane triacrylate, pentaerythritol triacrylate, pentaerythritol tetraacrylate, dipentaerythritol polyacrylate. Two or more types of plasticizers may be used in combination.

The thickness of the cushioning layer varies in accordance with the resin which is used as well as other conditions. However, usually, a layer thickness of 3 to 100 μm is preferable, 5 to 70 μm is more preferable, and 10 to 50 μm is even more preferable.

The image receiving layer and the cushioning layer must be adhered together up to the stage of transfer of the image from the photosensitive transfer sheet to the image receiving layer. Further, in order to transfer the image, which is formed on the image receiving layer, onto the printing paper, it is more preferable that the image receiving layer and the cushioning layer are provided so as to be peelable. Namely, the image and the image receiving layer may be transferred onto the printing paper. In order to facilitate peeling, it is preferable to provide a peelable layer of a thickness of about 0.1 to 2 μm between the cushioning layer and the image receiving layer.

The peelable layer preferably functions as a barrier with respect to the coating solvent at the time of coating of the image receiving layer.

As the structure of the image receiving sheet, an example is given in which the cushioning layer which is provided so as to be peelable is layered between the support and the image receiving layer. However, depending on the case, a support/cushioning image receiving layer structure or a support/undercoat layer/cushioning image receiving layer structure in which the image receiving layer also functions as a cushioning layer, can be used. In these cases as well, it is preferable for the cushioning image receiving layer to be peelably provided to enable transfer onto the printing paper.

The layer thickness of the image receiving layer which also functions as a cushioning layer is preferably 3 to 100 μm, more preferably 4 to 60 μm, and even more preferably 5 to 30 μm.

When the image is transferred from the image receiving sheet onto printing paper or the like, the image receiving layer can also be made to function as a protective layer for the image. Namely, when the image is transferred onto printing paper from the image receiving sheet after having been formed on the image receiving layer, it is preferable to form at least one image receiving layer from a photopolymerizable material from the standpoints of improvement of transferability and providing the function of a protective layer.

Examples of compositions of the photopolymerizable material are combinations of (a) a photopolymerizable monomer formed from at least one of a polyfunctional vinyl which can form a photopolymer by addition polymerization or a vinylidene compound which can form a photopolymer by addition polymerization, (b) an organic polymer, (c) a photopolymerization initiator, and as needed, additives such as thermal polymerization preventing agents.

Examples of the photopolymerizable vinyl monomer are unsaturated esters of polyol, and in particular, esters of acrylic acid or methacrylic acid (e.g., ethylene glycol diacrylate, pentaerythritol tetraacrylate).

Examples of the organic polymer are the same as the above-listed polymers that can be used as the image receiving layer binder polymer.

Examples of the photopolymerization initiator are ordinary photo-radical polymerization initiators such as benzophenone, Michler's ketone and the like. The photopolymerization initiator can be used in a ratio of 0.1 to 20% by weight with respect to the total weight of solids in the layer.

The image receiving layer of the present invention may be formed by a single layer or by plural layers. Preferable examples of an image receiving layer formed from plural layers are the image receiving sheets disclosed in Japanese Patent Application Publications (JP-B) Nos. 6-23845 and 7-19052, or all of the image receiving sheets disclosed as examples in these two publications, although the present invention is not limited to such structures.

Further, a peelable protective sheet can be provided on the image receiving layer of the image receiving sheet. The protective sheet can prevent the adhesion (blocking) of the image receiving layer and the backing surface at the time when the image receiving sheet is stored in a sheet shape or in a roll form.

Such an image receiving sheet is disclosed in detail in, for example, JP-A Nos. 2-244148 and 63-2037.

In the present invention, in the case of image formation using a photosensitive transfer sheet and an image forming sheet, a photosensitive transfer sheet, having a non-glossy color material layer which includes Y, M, C, K non-glossy color materials as the color materials and which does not contain an inorganic or a metal pigment, (i.e., a transfer sheet for non-glossy image formation) can also be used. Such a photosensitive transfer sheet having a non-glossy color material layer can be manufactured in the same way as in the present invention by substituting the metallic glossy pigment or inorganic white pigment used as the color material with a non-glossy coloring agent. Further, in a case in which the color material is a pigment having a large particle size or high specific gravity, it is useful to use the above-described precipitation prevention agent exhibiting thixotropy.

### Method of Heat Transfer Recording

The photosensitive transfer sheet of the present invention can be used as a material for printing color correction. For example, the photosensitive transfer sheet is recorded by operations (1) through (5) of the surprint method described hereinafter. As an example, explanation will be given of an aspect using the photosensitive transfer sheet of the present invention having a color material layer containing a metallic glossy pigment (hereinafter referred to upon occasion as “transfer sheet for metallic glossy image formation”). In this case, the above-described transfer sheet for non-glossy image formation can also be used.

(1) Usual printed matter has an image formed from standard colors (Y, M, C, K) other than an image having metallic gloss formed by a metallic glossy pigment. Accordingly, first, for the standard colors corresponding thereto, for example, a color separation mask is placed on and set in close contact with a black (K) photosensitive transfer sheet (transfer sheet for non-glossy image formation). Then, exposure is carried out by illuminating an active light beam (exposure step).

(2) By subjecting the exposed transfer sheet for non-glossy image formation to developing processing by using an alkali developing solution, a separated image is formed on the support of the transfer sheet (hereinafter referred to upon occasion as the “temporary support”). The black color proofing sheet is thereby prepared (developing step). Here, in a case in which the photosensitive transfer sheet is structured such that the color material layer and the photosensitive resin layer are layered as shown in FIGS. 2 and 3, when exposed regions of the photosensitive resin layer which is the upper layer are dissolved and removed by developing, simultaneously, the color material layer which is the lower layer is dissolved and removed, such that only the support or the peelable layer remains at these regions.

Examples of the alkali developing solution are aqueous solutions of sodium carbonate or sodium hydroxide or the like. Developing may be carried out by a known method such as spraying the developing solution onto the color material layer or the photosensitive resin layer, or immersing the color material layer or the photosensitive resin layer in the developing solution.

(3) At the time of forming a multicolor image, transfer sheets for non-glossy image formation of other colors may be used as needed. By repeating above steps (1) and (2), color proofing sheets of from two to four colors are respectively prepared.

(4) Next, above steps (1) and (2) are carried out as well for the photosensitive transfer sheet of the present invention which has the metallic glossy pigment (the transfer sheet for metallic glossy image formation). The metallic glossy separated image is formed on a temporary support, and a color proofing sheet having the metallic glossy separated image is prepared.

(5) After the proofing sheets of the respective colors have been prepared, the color proofing sheet on which the metallic glossy separated image is formed is superposed on the image receiving sheet such that the separated image side of this color proofing sheet contacts the surface of the image receiving layer of the image receiving sheet in which a photopolymerizable image receiving layer is provided on a support. Thereafter, these sheets are heated and pressed so as to be adhered together. The metallic glossy separated image is heat pressed in a state in which it is embedded within the image receiving layer which has not yet hardened. Next, by peeling the support of the photosensitive transfer sheet (the temporary support) from the image receiving sheet, the image is transferred onto the image receiving sheet such that the metallic glossy image is formed (transfer step).

Here, heat rollers, hot stamping or the like may be used as the method for heating and pressing. The heating temperature is preferably 40 to 140° C.

(6) Next, the same operations are carried out using the color proofing sheets of the other colors (the non glossy color proofing sheets). In this way, while coordinating the separated images from the second color on with the metallic glossy separated image of the first color, the images are successively transferred onto the same image receiving sheet. Images are transferred and formed onto the image receiving sheet in a state in which separated images of, for example, from two to five colors are embedded in the image receiving layer.

(7) The image receiving sheet onto which the multicolor image has been transferred is superposed on a white paper such that the multicolor image side contacts the white paper. The image transfer sheet and the white paper are heated and pressed so as to adhere to one another.

(8) Active light is irradiated onto the entire surface through the support of the image receiving sheet, and the photopolymerizable image receiving layer is photocured.

(9) Thereafter, by peeling the support of the image receiving sheet from the white paper, the multicolor image is transferred to and formed on the white paper. If desired, minute convex and concave portions may be formed in the surface of the image receiving layer by superposing and heating and pressing a matte film or the like on the image receiving layer.

In the above description, as an example of a final support onto which the multicolor separated images after plural transfers are finally transferred, the white paper is given. However, other than white paper, any of various types of paper, metal, film, glass or the like may be used.

Further, as described above, it is possible to directly transfer images onto the final support without using the image receiving sheet. The same type of support as that onto which the multicolor separated images after plural transfers are finally transferred can be used as the final support in this case.

By exactly and directly superposing the color proofing sheets of from two to five colors obtained in above step (3) as they are, the color proofing sheets can also be used as materials for color correction in accordance with the overlay method.

Examples of the light source for irradiating the active light are medium pressure to ultrahigh pressure mercury lamps, xenon lamps, metal halide lamps, and the like.

In the above description, metallic glossy pigments are used as an example of the inorganic pigment and/or metal pigment. However, the same is applicable for inorganic white pigments such as titanium oxide or the like.

### EXAMPLES

The present invention will be described hereinafter by Examples. However, the present invention is not to be limited to these Examples. Note that the “parts” and “%” in the Examples all indicate “parts by weight” and “% by weight”.

### Example 1

### Preparation of Photosensitive Transfer Sheet

### Preparation of Coating Solution for Peelable Layer

The coating solution for the peelable layer was prepared by mixing compounds of the following composition.

### Composition of Coating Solution for Peelable Layer

| | | |
|---|---|---|
| alcohol soluble polyamide (CM-8000, | 7.2 | parts |
| viscosity: 23 cps, manufactured by Toray Co., Ltd.) | | |
| polyhydroxystyrene (RESIN M, average | 1.8 | parts |
| molecular weight: 5500, manufactured by | | |
| Maruzen Sekiyu Co., Ltd.) | | |
| methanol | 400 | parts |
| methyl cellosolve | 100 | parts |

The above coating solution for the peelable layer was coated uniformly by a wheeler (rotary coating device) onto a support of polyethylene terephthalate film having a thickness of 100 μm, and was dried. A peelable layer having a layer thickness of 0.5 μm when dry was thereby formed.

### Preparation of Coating Solution for Photosensitive Color Material Layer

First, the compounds having the following compositions were mixed so as to prepare a mica pigment dispersion solution A (solution A), a precipitation prevention agent dissolved solution B (solution B), and a black pigment dispersion solution C (solution C).

### Composition of Mica Pigment Dispersion Solution A

| | | |
|---|---|---|
| mica pigment (IRIODIN 323, manufactured | 26.4 | parts |
| by Merck Japan Ltd.) | | |
| binder (benzyl methacrylate - methacrylic | 20 | parts |
| acid copolymer solution (copolymer ratio: 67:33; | | |
| limiting viscosity: 0.12 (at 25° C. in MEK)) | | |
| containing 30% solids, propylene glycol | | |
| monoethylether acetate solvent) | | |
| high molecular polycarbonate straight chain | 0.35 | parts |
| amine salt (wetting dispersing agent; | | |
| DISPARON #1831; manufactured by | | |
| Kusumoto Kasei Co., Ltd.) | | |
| toluene (solvent) | 21 | parts |
| cyclohexanol (solvent) | 5 | parts |

### Composition of Precipitation Prevention Agent Dissolved Solution B

| | | |
|---|---|---|
| fatty acid amide (dispersing preventing | 9 | parts |
| agent 1; DISPARON 6900-20X, content of | | |
| solids: 20%, manufactured by Kusumoto | | |
| Kasei Co., Ltd.) | | |
| polyethylene oxide (dispersing preventing | 26 | parts |
| agent 2; DISPARON 4200-10, content of | | |
| solids 10%, manufactured by Kusumoto | | |
| Kasei Co., Ltd.) | | |
| binder (benzyl methacrylate - methacrylic | 39.4 | parts |
| acid copolymer solution (copolymer ratio: 67:33; | | |
| limiting viscosity: 0.12 (at 25° C. in MEK)) | | |
| containing 30% solids, propylene glycol | | |
| monoethylether acetate solvent) | | |
| toluene (solvent) | 21 | parts |
| xylene (solvent) | 5 | parts |

### Composition of Black Pigment Dispersion Solution C

| | | |
|---|---|---|
| carbon black pigment (MA-100, | 0.52 | parts |
| Mitsubishi Kasei Co., Ltd.) | | |
| binder (benzyl methacrylate - methacrylic | 4.8 | parts |
| acid copolymer solution (copolymer ratio: 67:33; | | |
| limiting viscosity: 0.12 (at 25° C. in MEK)) | | |
| containing 30% solids, propylene glycol | | |
| monoethylether acetate solvent) | | |
| methylethylketone (solvent) | 1.34 | parts |
| propyleneglycol monoethylether acetate (solvent) | 1.34 | parts |

Next, by using the solutions A through C obtained above, a coating solution (1) for an N→P type photosensitive color material layer, which could form positive images from negative original images, was prepared.

### Composition of Coating Solution (1) for Photosensitive Color Material Layer

| | | |
|---|---|---|
| above mica pigment dispersion solution A | 72.8 | parts |
| above precipitation prevention agent dissolved solution B | 110.3 | |
| parts | | |
| above black pigment dispersion solution C | 8.0 | parts |
| binder (benzyl methacrylate - methacrylic | 26.6 | parts |
| acid copolymer solution (copolymer ratio: 67:33; | | |
| limiting viscosity: 0.12 (at 25° C. in MEK)) | | |
| containing 30% solids, propylene glycol | | |
| monoethylether acetate solvent) | | |
| photopolymerizable monomer (pentaerythritol | 24.7 | parts |
| tetraacrylate; A-TMMT, Shinnakamura | | |
| Kagaku Co., Ltd.) | | |
| photopolymerizable monomer (ethylene | 8.32 | parts |
| glycol (n = 9) diacrylate; A-400, | | |
| Shinnakamura Kagaku Co., Ltd.) | | |
| photopolymerization initiator | 0.94 | parts |
| (2-trichloromethyl-5-(P-butoxystyryl)- | | |
| 1,3,4-oxadiazole) | | |
| plasticizer (triphosphate, manufactured | 0.44 | parts |
| by Daiya Kagaku Co., Ltd.) | | |
| thermal polymerization inhibitor | 0.10 | parts |
| (P-methoxyphenol, manufactured by | | |
| Kawaguchi Kagaku Co., Ltd.) | | |
| surfactant (F-176P, manufactured by Dainippon | 0.39 | parts |
| Ink and Chemicals Inc.) | | |
| toluene (solvent) | 147 | parts |
| cyclohexanol (solvent) | 8.8 | parts |
| methylethylketone (solvent) | 26.6 | parts |
| propyleneglycol monoethyl ether acetate (solvent) | 8.2 | parts |

The coating solution (1) for a photosensitive color material layer obtained as described above was coated on the peelable layer formed on the support, and was dried. A photosensitive color material layer (metallic glossy color material layer) having a layer thickness when dry of 3.7 μm was thereby formed.

Further, a coating solution for a protective layer of the following composition was prepared. This coating solution for a protective layer was coated on the metallic glossy color material layer and was dried, such that a protective layer having a dried layer thickness of 1.5 μm was formed.

### Composition of Coating Solution for Protective Layer

| | |
|---|---|
| polyvinyl alcohol (PVA-205, manufactured | 60 parts |
| by Kuraray Co., Ltd.) | |
| water | 970 parts |
| methanol | 30 parts |

As described above, a negative type photosensitive transfer sheet (1) of the present invention was prepared in which the peelable layer, the metallic glossy color material layer (photosensitive color material layer), and the protective layer were laminated in that order on the support.

A mask was superposed on the photosensitive transfer sheet (1) obtained as described above, and the photosensitive transfer sheet was irradiated from a distance of 50 cm by a 2 kW ultrahigh pressure mercury lamp so as to be exposed imagewise. The exposed photosensitive transfer sheet (1) was subjected to developing processing for 10 to 20 seconds at a temperature of 35° C. by using a developing solution having the following composition. A color proofing sheet (1) (transfer sheet), on which a halftone dot image having metallic gloss was formed on the peelable layer, was thereby obtained.

### Composition of Developing Solution

| | |
|---|---|
| Na₂CO₃ | 15 parts |
| butyl cellosolve | 1 part |
| water | 1000 parts |

### Preparation of Image Receiving Sheet (1)

A polyethylene terephthalate film having a thickness of 100 μm was readied as a support. After the coating solution for a cushioning intermediate layer and the coating solution for an image receiving layer having the following compositions were prepared, the coating solution for a cushioning intermediate layer and the coating solution for an image receiving layer were coated on the support in that order such that the layers had a layer thickness when dry of 20 μm and 1.5 μm, respectively. An image receiving sheet (1) having a two-layer structure was thereby prepared.

### Composition of Coating Solution for Cushioning Intermediate Layer

| | | |
|---|---|---|
| ethylene-vinyl acetate copolymer | 15 | parts |
| (EVERFLEX #410, manufactured | | |
| by Mitsui Polychemical Co., Ltd.) | | |
| chlorinated polyethylene | 0.075 | parts |
| (SUPERKRON907LTA, | | |
| manufactured by Nippon Seishi Co., Ltd.) | | |
| fluorine-containing surfactant (F-176P, manufactured | 0.25 | parts |
| by Dainippon Ink and Chemicals Inc.) | | |
| toluene | 100 | parts |

### Composition of Coating Solution for Image Receiving Layer

| | | |
|---|---|---|
| polyvinylbutyral (manufactured by | 4 | parts |
| Denki Kagaku Kogyo KK) | | |
| fluorine-containing surfactant (F-176P, manufactured | 0.05 | parts |
| by Dainippon Ink and Chemicals Inc.) | | |
| methylalcohol (solvent) | 50 | parts |
| methylethyl ketone (solvent) | 20 | parts |
| methyl cellosolve acetate (solvent) | 20 | parts |

### Image Formation

The obtained color proofing sheet (1) and image receiving sheet (1) were superposed such that the image side (the side at which the photosensitive color material layer was provided) of the color proofing sheet (1) and the image receiving layer of the image receiving sheet contacted one another. Thereafter, by using a laminator (FAST LAMINATOR 8B-550-80, manufactured by Taisei Shoji Co., Ltd.), the color proofing sheet (1) and the image receiving sheet (1) were laminated at 2 atm, a roller temperature of 120° C., and a speed of 900 mm/min. Only the support of the color proofing sheet (1) was peeled off from the peelable layer, and the image was transferred together with the peelable layer onto the image receiving sheet (1).

The image receiving sheet (1) on which the image was transferred was superposed on a white art paper such that the image receiving layer side of the image receiving sheet (1) contacted the white art paper. Thereafter, the image receiving sheet (1) and the white art paper were laminated under the same conditions as those listed above. When the image receiving sheet was peeled off from the white art paper, the image receiving sheet was peeled off between the image receiving layer and the cushioning intermediate layer of the image receiving sheet. The image receiving sheet, the peelable layer, and the image-form metallic glossy color material layer (image portions) remained on the white art paper, and a gold-colored image having high metallic gloss which resembled the printed matter was obtained without subjecting the surface of the image portions to a matting process. The color tone of the image was uniform. At the formed image, the peelable layer, the image-form color material layer (image portions), and the image receiving layer serving as the protective layer were layered in that order.

### Comparative Example 1

A photosensitive transfer sheet (2) was prepared in the same way as in Example 1, except that the wetting dispersing agent used in the preparation of the mica pigment dispersion solution A in Example 1 and the precipitation prevention agents 1 and 2 used in the preparation of the precipitating preventing dissolved solution B in Example 1 were not used.

Using the photosensitive transfer sheet (2), in the same way as in Example 1, an image having a gold color metallic gloss which resembled the printed matter was formed on white art paper. However, the pigment precipitated in the dispersion solution, and a coated film having a uniform content of pigment could not be formed. Further, the color tone of the color material layer after drying was not uniform, such that the image had many portions having a low level of metallic gloss.

### Examples 2-5

Photosensitive transfer sheets (3) through (6) of the present invention were obtained in the same manner as in Example 1, except that that the added amount of the wetting dispersing agent used in the preparation of the mica pigment dispersion solution A of Example 1 and the added amounts of the precipitation prevention agents 1 and 2 used in the preparation of the precipitating preventing dissolved solution B were replaced by the amounts shown in following Table 1.

Further, by using the photosensitive transfer sheets (3) through (6), in the same way as in Example 1, images each having a gold color metallic gloss were formed from the peelable layer and the image-form metallic glossy color material layer (image portions) and the image receiving layer on the white art papers. The formed images had a high metallic gloss and resembled the printed matter. The color tones thereof were extremely uniform.

TABLE 1

| | | | Composition of Solution B | |
|---|---|---|---|---|
| | Composition of Solution A | | | Amount of |
| | | Amount of | | Precipitation |
| | | Dispersing Agent | | Prevention Agent |
| | Mica Pigment | (parts by weight | Precipitation | (parts by weight |
| | Dispersing Agent | in solution A) | Prevention Agent | in solution B) |
| Example | DISPARON #1831 | 0.35 | DISPARON 6900-20X | 7.9 |
| 1 | | | DISPARON 4200-10 | 23.6 |
| Comp. | — | — | — | — |
| Ex. 1 | | | — | — |
| Example | DISPARON #1831 | 0 | DISPARON 6900-20X | 7.9 |
| 2 | | | DISPARON 4200-10 | 23.6 |
| Example | DISPARON #1831 | 0.1 | DISPARON 6900-20X | 7.9 |
| 3 | | | DISPARON 4200-10 | 23.6 |
| Example | DISPARON #1831 | 0.35 | DISPARON 6900-20X | 2 |
| 4 | | | DISPARON 4200-10 | 6 |
| Example | DISPARON #1831 | 0.5 | DISPARON 6900-20X | 12 |
| 5 | | | DISPARON 4200-10 | 36 |

### Examples 6-9

Photosensitive transfer sheets (7-10) of the present invention were prepared in the same way as Example 1, except that, instead of the wetting dispersing agent used in the preparation of the mica pigment dispersion solution A in Example 1, the wetting dispersing agents shown in following Table 2 were used.

Using the photosensitive transfer sheets (7) through (10), in the same way as in Example 1, an image having gold color metallic gloss and formed from the peelable layer, the image-form metallic gloss color material layer (image portions) and image receiving layer on white art paper, was formed. The formed image had a high metallic gloss and resembled the printed matter, and the color tone thereof as well was extremely uniform.

TABLE 2

| | Composition of Solution A | | Composition of Solution B | |
|---|---|---|---|---|
| | | Amount of | | Amount of Precipitation |
| | | Dispersing Agent | | Prevention Agent |
| | Mica Pigment | (parts by weight | Precipitation | (parts by weight |
| | Dispersing Agent | in solution A) | Prevention Agent | in solution B) |
| Example | PW-36 | 0.35 | DISPARON 6900-20X | 7.9 |
| 6 | (phosphate based | | DISPARON 4200-10 | 23.6 |
| | surfactant) | | | |
| Example | DISPARON #1210 | 0.35 | DISPARON 6900-20X | 7.9 |
| 7 | (aliphatic | | DISPARON 4200-10 | 23.6 |
| | polycarboxylic acid) | | | |
| Example | DISPARON #2150 | 0.35 | DISPARON 6900-20X | 7.9 |
| 8 | (aliphatic | | DISPARON 4200-10 | 23.6 |
| | polycarboxylic acid) | | | |
| Example | DISPARON #1860 | 0.35 | DISPARON 6900-20X | 7.9 |
| 9 | (long chain | | DISPARON 4200-10 | 23.6 |
| | polyamino amanoid) | | | |

### Examples 10-12

Photosensitive transfer sheets (11) through (13) of the present invention were prepared in the same way as in Example 1, except that the two types of precipitation prevention agents shown in following Table 3 were used in place of the two types of precipitation prevention agents (precipitation prevention agents 1 and 2) used in the preparation of the mica pigment dispersion solution B in Example 1.

Further, by using the photosensitive transfer sheets (11) through (13), in the same way as in Example 1, an image having gold color metallic gloss and formed from a peelable layer, an image-form metallic glossy color material layer (image portions) and an image receiving layer on white art paper, was formed. The formed image had a high metallic gloss and resembled the printed matter, and the color tone thereof was extremely uniform.

TABLE 3

| | Composition of Solution A | | Composition of Solution B | |
|---|---|---|---|---|
| | | Amount of | | Amount of Precipitation |
| | | Dispersing Agent | | Prevention Agent |
| | Mica Pigment | (parts by weight | Precipitation | (parts by weight |
| | Dispersing Agent | in solution A) | Prevention Agent | in solution B) |
| Example | DISPARON #1831 | 0.35 | zinc stearate | 0.8 |
| 10 | | | DISPARON 4200-10 | 23.6 |
| Example | DISPARON #1831 | 0.35 | aluminum palmitate | 0.8 |
| 11 | | | DISPARON 4200-10 | 23.6 |
| Example | DISPARON #1831 | 0.35 | aluminum palmitate | 0.9 |
| 12 | | | DISPARON 6900-20X | 7.9 |

### EVALUATION

### Evaluation of Coating Solution for Photosensitive Color Material Layer

(1) Precipitated Amount of Mica Pigment after Stirring had been Stopped for Two Hours

For each of the coating solutions for a photosensitive color material layer prepared in the above Examples and Comparative Example, the amount of the mica pigment which precipitated in the coating solution two hours after stirring had been stopped was observed visually and was evaluated in accordance with the following criteria.

### Criteria

⊚: Stable dispersion exhibited, extremely good.

◯: Extremely slight amount of precipitating of the mica pigment, but good.

Δ: Some precipitating of the mica pigment observed, but to the extent that would not cause problems in practice.

X: Marked precipitating of the mica pigment, to the extent that practical use is not possible.

(2) Amount of Precipitating of Mica Pigment After Stirring Again

For each of the coating solutions for a photosensitive color material layer prepared in the above Examples and Comparative Example, they were stirred again and coated, and the amount of mica pigment which precipitated in the coating solution after stirring again was evaluated by observing the photosensitive color material layer after coating by using a 300× optical microscope (manufactured by Olympus Optical Co., Ltd.), and judging the degree of dispersion of the mica pigment (the presence or absence of aggregations of the pigment) in accordance with the following criteria.

### Criteria

⊚: The mica pigment was present uniformly in the layer, which was good.

◯: There were some portions in the layer at which there was a slightly larger amount of mica pigment, but the uniformity was good, i.e., there was extremely little aggregation of pigment after redispersion.

Δ: There were some agglomerated portions of mica pigment in the layer, but not to the extent that problems would be caused in practice, i.e., there was a slight amount of pigment aggregation after redispersion.

X: There was an imbalance in the amount of mica pigment that existed in the layer, such that a uniform metallic gloss could not be obtained, i.e., aggregation of the mica pigment was marked after redispersion.

### Evaluation of Coated Surface Quality of Photosensitive Color Material Layer

In each of the photosensitive transfer sheets (1) through (13) prepared in the above Examples and Comparative Example, the coated surface quality of the photosensitive color material layer before formation of the protective layer was visually inspected, and the degree of dispersion of the mica pigment was evaluated in accordance with the following criteria.

### Criteria

⊚: The degree of metallic gloss was high, and an extremely uniform color tone was obtained.

◯: The degree of metallic gloss was high, and the color tone was uniform.

Δ: There was a slight amount of non-uniformity in the metallic gloss, but not to the extent that it presented problems in practice.

X: The degree of metallic gloss was low, and the color tone was non-uniform.

TABLE 4

| | | | | | | Stability of Coating | | |
|---|---|---|---|---|---|---|---|---|
| | | | | | | Solution for | | |
| | | | | | | Photosensitive Color | | |
| | | Composition of | | Composition of | | Material Layer | | |
| | | Solution A | | Solution B | | Settled Amount | Dispersability | Coated Surface |
| | | Mica | Amount of | | Amount of | of Mica | of Mica | Quality of |
| | Transfer | Pigment | Wetting | Precipitation | Precipitation | Pigment after | Pigment | Photosensitive |
| | Sheet | Dispersing | Dispersing | Prevention | Prevention | Stirring Stopped | After | Color |
| | Type | Agent | Agent(*1) | Agent | Agent(*2) | for 2 Hours | Stirring Again | Material Layer |
| Ex. 1 | (1) | DISPARON | 0.35 | DISPARON | 7.9 | ⊚ | ⊚ | ⊚ |
| | | #1831 | | 6900-20X | | | | |
| | | | | DISPARON | 23.6 | | | |
| | | | | 4200-10 | | | | |
| Comp. Ex. | (2) | — | — | — | — | X | X | X |
| 1 | | | | — | — | | | |
| Ex. 2 | (3) | DISPARON | 0 | DISPARON | 7.9 | ◯ | Δ | Δ |
| | | #1831 | | 6900-20X | | | | |
| | | | | DISPARON | 23.6 | | | |
| | | | | 4200-10 | | | | |
| Ex. 3 | (4) | DISPARON | 0.1 | DISPARON | 7.9 | ◯ | ◯ | ◯ |
| | | #1831 | | 6900-20X | | | | |
| | | | | DISPARON | 23.6 | | | |
| | | | | 4200-10 | | | | |
| Ex. 4 | (5) | DISPARON | 0.35 | DISPARON | 2 | ◯ | ◯ | ◯ |
| | | #1831 | | 6900-20X | | | | |
| | | | | DISPARON | 6 | | | |
| | | | | 4200-10 | | | | |
| Ex. 5 | (6) | DISPARON | 0.5 | DISPARON | 12 | ⊚ | ⊚ | ⊚ |
| | | #1831 | | 6900-20X | | | | |
| | | | | DISPARON | 36 | | | |
| | | | | 4200-10 | | | | |
| Ex. 6 | (7) | PW-36(*3) | 0.35 | DISPARON | 7.9 | ⊚ | ◯ | ◯ |
| | | (phosphate | | 6900-20X | | | | |
| | | surfactant) | | DISPARON | 23.6 | | | |
| | | | | 4200-10 | | | | |
| Ex. 7 | (8) | DISPARON | 0.35 | DISPARON | 7.9 | ⊚ | ◯ | ◯ |
| | | #1210(*4) | | 6900-20X | | | | |
| | | (aliphatic | | DISPARON | 23.6 | | | |
| | | poly- | | 4200-10 | | | | |
| | | carboxylic | | | | | | |
| | | acid) | | | | | | |
| Ex. 8 | (9) | DISPARON | 0.35 | DISPARON | 7.9 | ⊚ | ⊚ | ◯ |
| | | #2150(*5) | | 6900-20X | | | | |
| | | (aliphatic | | DISPARON | 23.6 | | | |
| | | poly- | | 4200-10 | | | | |
| | | carboxylic | | | | | | |
| | | acid) | | | | | | |
| Ex. 9 | (10) | DISPARON | 0.35 | DISPARON | 7.9 | ⊚ | ◯ | ◯ |
| | | #1860(*6) | | 6900-20X | | | | |
| | | (long chain | | DISPARON | 23.6 | | | |
| | | polyamino | | 4200-10 | | | | |
| | | amanoid) | | | | | | |
| Ex. 10 | (11) | DISPARON | 0.35 | zinc stearate | 0.8 | ⊚ | ◯ | ◯ |
| | | #1831 | | DISPARON | 23.6 | | | |
| | | | | 4200-10 | | | | |
| Ex. 11 | (12) | DISPARON | 0.35 | aluminum | 0.8 | ⊚ | ⊚ | ◯ |
| | | #1831 | | palmitate | | | | |
| | | | | DISPARON | 23.6 | | | |
| | | | | 4200-10 | | | | |
| Ex. 12 | (13) | DISPARON | 0.35 | DISPARON | 7.9 | ⊚ | ◯ | ◯ |
| | | #1831 | | 6900-20X | | | | |
| | | | | aluminum | 0.9 | | | |
| | | | | palmitate | | | | |

(*1): parts by weight in mica pigment dispersion solution A
(*2): parts by weight in precipitation prevention agent dissolved solution B
(*3) through (*6): manufactured by Kusamoto Kasei Co., Ltd.

As can be seen from the results of Table 4, in the Examples using the precipitation prevention agents in the coating solution for formation of the photosensitive color material layer, a coating solution in which precipitating of the mica pigment was suppressed and which had excellent dispersability was obtained, and an image having high metallic gloss and a uniform color tone could be formed. By also using the wetting dispersing agent, the dispersion stability was improved, and an image which was similar to the printed matter and which had a more uniform and high metallic gloss could be obtained.

In contrast, in Comparative Example 1 which did not use a precipitation prevention agent, the precipitating of the mica pigment was marked, and sufficient dispersability could not be obtained. Further, the degree of metallic gloss of the formed image was low, and the uniformity thereof was poor.

### Example 13

A photosensitive transfer sheet (14) of the present invention was prepared in the same way as in Example 1, except that, in place of the mica pigment used in the preparation of mica pigment dispersion solution A in Example 1, bismuth oxychloride (BiOCl, trade name: BIRON, average particle thickness: 0.06 μm, particle size: 8 to 15 μm, manufactured by Merck Japan Ltd.) was used.

By using the photosensitive transfer sheet (14), in the same way as in Example 1, an image having a gold color metallic gloss and formed from the peelable layer, the image-form metallic glossy color material layer (image portions) and image receiving layer on white art paper, was formed. The formed image had a high metallic gloss resembling the printed matter, and the color tone thereof was also extremely uniform. The same evaluations as those in Example 1 were carried out on the coating solution for a photosensitive color material layer and the coated surface quality of the photosensitive color material layer. The dispersability of the bismuth oxychloride was good (evaluation:⊚), and the coated surface quality of the photosensitive color material layer was good (evaluation:⊚).

### Example 14

A photosensitive transfer sheet (15) of the present invention was prepared in the same way as in Example 1, except that, in place of the mica pigment used in the preparation of mica pigment dispersion solution A in Example 1, an aluminum metal fine powder pigment (average particle diameter 3 μm) was used.

Using the photosensitive transfer sheet (15), in the same way as in Example 1, an image having a gold metallic gloss and formed from the peelable layer, the image-form metallic glossy color material layer (image portions) and the image receiving layer on white art paper, was formed. The formed image had a high metallic gloss resembling the printed matter, and the color tone thereof was also extremely uniform. The same evaluations as those in Example 1 were carried out on the coating solution for a photosensitive color material layer and the coated surface quality of the photosensitive color material layer. The dispersability of the pigment was good (evaluation:⊚), and the coated surface quality of the photosensitive color material layer was good (evaluation:⊚).

### Example 15

### Preparation of Transfer Sheet for Non-Glossy Image Formation

The compounds of the compositions shown in following Table 5 were mixed together as coating solutions for an N→P type photosensitive color material layer, which enables formation of a positive image from a negative original image, so as to prepare four coating solutions (Y, M, C, K) for a photosensitive color material layer of yellow (Y), magenta (M), cyan (C) and black (K).

TABLE 5

| | Coloring Solution for Photosensitive Color | | | |
|---|---|---|---|---|
| | Material Layer (parts by weight) | | | |
| | yellow | magenta | cyan | black |
| | (Y) | (M) | (C) | (K) |
| benzyl methacrylate - | 60 | 60 | 60 | 60 |
| methacrylic acid | | | | |
| copolymer (composition | | | | |
| ratio: 67:33) | | | | |
| pentaerythitrol tetra- | 43.2 | 43.2 | 43.2 | 43.2 |
| acrylate | | | | |
| Michler's ketone | 2.4 | 2.4 | 2.4 | 2.4 |
| 2-(o-chlorophenyl)-4,5- | 2.5 | 2.5 | 2.5 | 2.5 |
| diphenylimidazole dimer | | | | |
| SEIKA FAST YELLOW | 9.4 | — | — | — |
| II-0755 (manufactured by | | | | |
| Dainichi Seika Colour & | | | | |
| Chemicals Mfg. Co., | | | | |
| Ltd.) | | | | |
| SEIKA FAST CARMINE | — | 5.2 | — | — |
| 1483 (manufactured by | | | | |
| Dainichi Seika Colour & | | | | |
| Chemicals Mfg. Co., Ltd.) | | | | |
| CYANINE BLUE | — | — | 5.6 | — |
| (manufactured by Dainichi | | | | |
| Seika Colour & Chemicals | | | | |
| Mfg. Co., Ltd.) | | | | |
| MITSUBISHI CARBON | — | — | — | 6.6 |
| BLACK (manufactured by | | | | |
| Mitsubishi Chemical Corp.) | | | | |
| methyl cellosolve acetate | 560 | 560 | 560 | 560 |
| methylethyl ketone | 280 | 280 | 280 | 280 |

Four supports, which were the same as those in Example 1 and on which a peelable layer was formed, were prepared. One of the coating solutions (Y, M, C, K) for a photosensitive resin layer was coated on the peelable layer of the support and dried, such that a photosensitive non-glossy color material layer having a dried layer thickness of 2.4 μm was formed on each of the supports. A protective layer which was the same as that of Example 1 was formed on each of the non-glossy color material layers, so as to prepare four transfer sheets (Y, M, C, K) for non-glossy image formation.

Next, a photosensitive transfer sheet (1) which was the same as that of Example 1 was readied. In the same way as in Example 1, the photosensitive transfer sheet (1) was exposed and developed so that a color proofing sheet (1′) having a halftone dot image with a metallic gloss on the peelable layer was obtained. Each of the four transfer sheets (Y, M, C, K) for non-glossy image formation obtained as described above was superposed with a corresponding mask by register pins, and was illuminated from a distance of 50 cm by a 2 kW ultrahigh pressure mercury lamp such that imagewise exposure was carried out. The exposed transfer sheets for non-glossy image formation were subjected to developing processing under the same conditions as those in Example 1 by the developing solution prepared in Example 1, such that color proofing sheets (Y, M, C, K) having halftone dot images of the colors were formed on their peelable layers.

### Image Formation

An image receiving sheet (1) which was the same as that of Example 1 was readied. First, the black color proofing sheet (K) obtained as described above was superposed correctly by using the register pins such that the color proofing sheet (K) contacted the surface of the image receiving layer of the image receiving sheet (1). Thereafter, the black image was formed on the image receiving layer in the same way as in Example 1 by using the laminator used in Example 1.

Next, for the color proofing sheets (C), (M), (Y), and (1′) as well, the processes for transfer onto the image receiving layer of the image receiving sheet (1) were repeated in order by the same method, such that halftone dot images of black, cyan, magenta, yellow and gold were formed in order.

The image receiving sheet (1) onto which the images had been transferred was superposed onto a white art paper such that the image receiving surface side thereof contacted the white art paper, and the image receiving sheet (1) and the white art paper were laminated under the same conditions as in Example 1. When the image receiving sheet was peeled from the white art paper, it was peeled between the image receiving layer and the cushioning intermediate layer of the image receiving sheet, and the peelable layer and the image-form color material layers remained together with the image receiving layer on the white art paper. A multicolor image resembling the printed matter could be obtained without subjecting the surface to matte processing. The formed image had high metallic gloss, and the color tone thereof was extremely uniform.

### Example 16

Instead of the image receiving sheet (1) prepared and used in Example 1, the following image receiving sheet (2) was used. In the same way in Example 1, a metallic glossy image was transferred onto the image receiving sheet (2). The image receiving sheet (2) onto which an image had been transferred was superposed and laminated with white art paper in the same way as in Example 1. Thereafter, an image having a gold metallic gloss was formed on the white art paper in the same way as in Example 1, except that the entire surface was irradiated from a distance of 50 cm by using a 2 kW ultrahigh pressure mercury lamp through the image receiving sheet from the support side of the image receiving sheet (2).

In this case, after the image receiving sheet (2) having the image and the white art paper had been superposed and laminated, light was illuminated with the sheet and the paper in this superposed state such that a photopolymerization reaction occurred in the image receiving layer itself and the image receiving layer hardened. When the image receiving sheet was peeled off and a metallic glossy image was formed on the white art paper, the image receiving sheet was peeled off between the support and the photopolymerizable image receiving layer of the image receiving sheet. The peelable layer and the image-form color material layer (image portions) were, together with the polymer-cured image forming layer, transferred onto the white art paper.

In the image formed in the above manner, the peelable layer and the image-form color material layer (image portions) and the image receiving layer serving as the protective layer were laminated in that order. The image had a high metallic gloss resembling the printed matter, and the color tone thereof was extremely uniform.

### Preparation of Image Receiving Sheet (2)

A polyethylene terephthalate film having a thickness of 100 μm was readied as the support. After the coating solution for a photopolymerizable image receiving layer having the following composition was prepared, the coating solution was coated onto the support such that the layer thickness when dry was 20 μm. The image receiving sheet (2) was thereby prepared.

### Composition of Coating Solution for Photopolymerizable Image Receiving Layer

| | | |
|---|---|---|
| methyl methacrylate polymer | 85 | parts |
| (average molecular weight 100000) | | |
| vinyl chloride - vinyl acetate - vinyl | 8 | parts |
| alcohol copolymer (ESREK A, manufactured | | |
| by Sekisui Chemical Co., Ltd.) | | |
| benzoin methyl ether | 5 | parts |
| paramethoxyphenol | 0.09 | parts |
| trimethyloyl propane trimethacrylate | 60 | parts |
| methylethyl ketone | 300 | parts |

In accordance with the present invention, a photosensitive transfer sheet is provided which has a color material layer in which, at the time of manufacture, deterioration in pigment dispersability due to precipitating of the inorganic pigment and/or metal pigment in the coating solution is suppressed and the inorganic pigment and/or metal pigment is dispersed uniformly, and which enables formation of an image (color proof) having a high degree of metallic gloss or a high degree of whiteness and a uniform color tone.

What is claimed is:

1. A photosensitive transfer sheet comprising:
a support; and
a color material layer containing an inorganic pigment and/or a metal pigment, a binder, and a precipitation prevention agent.

2. A photosensitive transfer sheet according to claim 1, wherein the precipitation prevention agent is a thixotropic agent.

3. A photosensitive transfer sheet according to claim 2, wherein the thixotropic agent is a fatty acid amide or a polyethylene oxide.

4. A photosensitive transfer sheet according to claim 1, wherein the inorganic pigment and/or metal pigment is a pearl pigment or a metal fine powder pigment.

5. A photosensitive transfer sheet according to claim 4, wherein the pearl pigment is selected from the group consisting of natural pearl essence, mercury chloride, basic white lead, bismuth oxychloride, and mica.

6. A photosensitive transfer sheet according to claim 4, wherein the pearl pigment is mica having a thickness of 0.05 to 0.7 μm and a particle size of 1 to 50 μm.

7. A photosensitive transfer sheet according to claim 1, wherein the inorganic pigment is a white color pigment.

8. A photosensitive transfer sheet according to claim 7, wherein the white color pigment is titanium oxide or calcium carbonate.

9. A photosensitive transfer sheet according to claim 1, wherein the metal fine powder pigment is a fine powder pigment of at least one metal selected from the group consisting of aluminum, gold, silver, copper and zinc.

10. A photosensitive transfer sheet according to claim 2, wherein the thixotropic agent is a higher aliphatic compound.

11. A photosensitive transfer sheet according to claim 1, further comprising at least one layer selected from the group consisting of a photosensitive resin layer, a peelable layer, a protective layer and a backing layer.

12. A photosensitive transfer sheet according to claim 1, wherein the color material layer includes at least one of a photosensitive resin, a non-glossy coloring agent, and a wetting dispersing agent.

13. A photosensitive transfer sheet according to claim 1, wherein an amount of the inorganic pigment and/or metal pigment contained in the color material layer is 0.1 to 10 g/m², and the binder is a thermoplastic polymer soluble in a developing solution used for developing.

14. A photosensitive transfer sheet according to claim 1, wherein an amount of the precipitation prevention agent added in the color material layer is 0.01 to 2 parts by weight with respect to 1 part by weight of the organic or metal pigment.

15. A photosensitive transfer sheet according to claim 1, wherein the color material layer is provided on the support.

16. A photosensitive transfer sheet according to claim 1, further comprising:
a photosensitive resin layer provided on the color material layer and containing a photopolymerizable monomer, a photopolymerization initiator, and a binder.

17. A method of forming a photosensitive transfer sheet comprising the steps of:
(a) forming a solution containing at least an inorganic pigment and/or a metal pigment, a precipitation prevention agent, and a binder;
(b) coating a support material with the solution; and
(c) drying the coating.

18. A method of forming a photosensitive transfer sheet according to claim 17, wherein the precipitation prevention agent is a thixotropic agent.

19. A method of forming a photosensitive transfer sheet according to claim 18, wherein the thixotropic agent is a fatty acid amide or a polyethylene oxide.

20. A method of forming a photosensitive transfer sheet according to claim 17, wherein the inorganic pigment and/or metal pigment is a pearl pigment or a metal fine powder pigment.
